(19) United States
(12) Patent Application Publication
(10) Pub. No.: US 2024/0289447 A1
(43) Pub. Date: Aug. 29, 2024

(54) SYSTEMS AND METHODS FOR AUTOMATED CYBERSECURITY THREAT TESTING AND DETECTION

(71) Applicant: State Farm Mutual Automobile Insurance Company, Bloomington, IL (US)

(72) Inventors: Andrew D. Blessing, Bloomington, IL (US); Christina E. Phillips, Farmers Branch, TX (US); Stephanie P. Klingele, Richardson, TX (US)

(21) Appl. No.: 18/441,758

(22) Filed: Feb. 14, 2024

Related U.S. Application Data
(60) Provisional application No. 63/487,528, filed on Feb. 28, 2023.

(51) Int. Cl. G06F 21/55

(52) U.S. Cl. CPC G06F 21/554

(57) ABSTRACT

A system for analyzing networks for potential vulnerabilities to cyber-attacks configured to (i) receive a plurality of indicators of compromise associated with active threat actors; (ii) generate a plurality of validation tests to test for the plurality of indicators of compromise; (iii) execute the plurality of validation tests in a simulation environment to generate a plurality of results; (iv) analyze the plurality of results to detect one or more failed validation tests of the plurality of validation tests; (v) scan a plurality of system and/or security logs of the computer network for indicators of compromise associated with the one or more failed validation tests; (vi) determine whether the computer network is compromised based on the scan of the plurality of system and/or security logs; and (vii) report threat posture information about a computer network and systems as a form of threat intelligence.

### CROSS-REFERENCE TO RELATED APPLICATIONS

This application claims the benefit of priority to U.S. Provisional Patent Application Ser. No. 63/487,528, filed Feb. 28, 2023, the entire contents and disclosure of which is hereby incorporated herein by reference in its entirety.

### FIELD OF THE DISCLOSURE

The present disclosure relates to automated cybersecurity defense testing and, more particularly, to a network-based system and method for analyzing computer systems and networks for potential compromise and vulnerabilities to cyber-attacks.

### BACKGROUND

In cybersecurity testing and protection, many computer networks rely on their security tools to protect their networks from malicious actors. However, there is a lag between when new methods of compromise are developed and put into use, and when the security tools are updated to detect and protect from those new methods of compromise. Many companies have cyber threat intelligence teams that evaluate and track threats that may target and impact their networks. A critical part of threat intelligence is assessing the networks' threat posture for would-be threats and utilizing telemetry to make informed decisions guiding security operations.

Threat intelligence teams within Security Operation Centers (SOC) have to assess and understand threats. This includes manual work to understand known tactics and attempting to determine the current posture of tools, networks, and systems would be for attacks. As attackers are known to use a variety of different techniques, such as exploiting zero-day vulnerabilities (e.g., on an endpoint) or conducting phishing campaigns in the hopes of a user clicking on a link, identifying, sharing, and utilizing Indicators of Compromise (IOCs) are a common means of reactively determining if threats have been observed and verified on a network and computer systems. This includes using IOCs to perform basic threat hunting, generating monitoring alerts, and sharing threat intelligence information about active attacks. However, attackers are increasingly capable of shifting their tactics using different domains, variants of malware, and additional other resources that increases the likelihood that they are able to bypass controls and obtain access. This increases pressures on Incident Response teams and increases alert fatigue on SOC analysts.

To better address these threats, a proactive means of assessing threats is needed.

### BRIEF SUMMARY

The present embodiments may relate to systems and methods for testing and analyzing computer systems and networks for potential compromise and vulnerabilities to cyber-attacks. The platform may include a vulnerability and compromise detection (“VCD”) computer system and/or a plurality of user computer devices. The platform may include generating threat intelligence reports characterizing computer systems and network threat posture.

In one aspect, a vulnerability and compromise detection (“VCD”) system for testing and analyzing computer networks for potential vulnerabilities and assess systems in view of cyber-attacks is provided. The VCD system includes at least one computer device including at least one processor in communication with at least one memory device. The at least one processor is programmed to receive a plurality of indicators of compromise associated with active threat actors. The at least one processor is also programmed to generate a plurality of validation tests to test for the plurality of indicators of compromise. The at least one processor is further programmed to execute the plurality of validation tests in a simulation environment against network security controls to generate a plurality of results. In addition, the at least one processor is programmed to analyze the plurality of results to detect one or more failed validation tests of the plurality of validation tests. Moreover, the at least one processor is programmed to scan a plurality of system and/or security logs of the computer network for indicators of compromise associated with the one or more failed validation tests. Furthermore, the at least one processor is programmed to determine whether the computer network is compromised based on the scan of the plurality of system and/or security logs. Additionally, the at least one processor is programmed to report threat posture information about computer network and systems as a form of threat intelligence. Lastly, the at least one processor is programmed to generate a computer and network systems IOC threat posture report for the active threats. The system may have additional, less, or alternate functionalities, including those discussed elsewhere herein.

In another aspect, a computer-based method for testing and analyzing computer networks for potential vulnerabilities to cyber-attacks is provided. The method is implemented on a vulnerability and compromise detection (“VCD”) computer device including at least one processor in communication with at least one memory device. The method includes receiving a plurality of indicators of compromise associated with active threat actors. The method also includes generating a plurality of validation tests to test for the plurality of indicators of compromise. The method further includes executing the plurality of validation tests in a simulation environment against security controls to generate a plurality of results. In addition, the method includes analyzing the plurality of results to detect one or more failed validation tests of the plurality of validation tests. Moreover, the method includes scanning a plurality of system and/or security logs of the computer network for indicators of compromise associated with the one or more failed validation tests. Furthermore, the method includes determining whether or not the computer network is compromised based on the scan of the plurality of system and/or security logs. Additionally, the method includes reporting threat posture information about computer network and systems as a form of threat intelligence. Lastly, the method includes creating a computer and systems IOC threat posture report for the active threats. The method may have additional, less, or alternate functionalities, including those discussed elsewhere herein.

In yet another aspect, at least one non-transitory computer-readable storage media having computer-executable instructions embodied thereon may be provided. When executed by at least one processor, the computer-executable instructions may cause the processor to receive a plurality of indicators of compromise associated with active threat actors. The computer-executable instructions may also cause the processor to generate a plurality of validation tests to test for the plurality of indicators of compromise. The computer-executable instructions may further cause the processor to execute the plurality of validation tests in a simulation environment to generate a plurality of results. In addition, the computer-executable instructions may cause the processor to analyze the plurality of results to detect one or more failed validation tests of the plurality of validation tests. Moreover, the computer-executable instructions may cause the processor to scan a plurality of system and/or security logs of a computer network for indicators of compromise associated with the one or more failed validation tests. Furthermore, the computer-executable instructions may cause the processor to determine whether the computer network is compromised based on the scan of the plurality of system and/or security logs. Additionally, the computer executable instructions may cause the processor to report threat posture information about computer network and systems as a form of threat intelligence. Lastly, the computer executable instructions may cause the processor to generate a computer and systems IOC threat posture report for the active threats. The computer-readable storage media may have additional, less, or alternate functionalities, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown.

FIG. 1 illustrates a simplified block diagram of a system for vulnerability and compromise detection of computer systems and networks for potential vulnerabilities to cyber-attacks, in accordance with at least one embodiment.

FIG. 2 illustrates a timing flow chart of an exemplary process of vulnerability and compromise detection of computer systems and networks for potential vulnerabilities to cyber-attacks using the system shown in FIG. 1.

FIG. 3 illustrates a flow chart of an exemplary computer-implemented process for vulnerability and compromise detection of computer systems and networks for potential vulnerabilities to cyber-attacks as shown in FIG. 2 using the system shown in FIG. 1.

FIG. 4 illustrates a simplified block diagram of an exemplary computer system for implementing the processes shown in FIGS. 2 and 3.

FIG. 5 illustrates an exemplary configuration of a client computer device, in accordance with one embodiment of the present disclosure.

FIG. 6 illustrates an exemplary configuration of a server system, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for analyzing computer systems and networks for potential compromise and vulnerabilities to cyber-attacks. In one exemplary embodiment, the methods may be performed by a vulnerability and compromise detection (“VCD”) computer device, also known as a vulnerability and compromise detection (“VCD”) server. The platform may include generating threat intelligence reports characterizing computer systems and network threat posture.

Threat intelligence platforms enable Cyber Threat Intel (CTI) teams to research, evaluate and assess threats known to be targeting different industries, such as the financial service industry, for example. The CTI teams use a variety of information sources/types, including, but not limited to threat actor profiles, campaigns, threat bulletins, malware family, vulnerabilities, and more. In addition, CTI Teams on Information Sharing and Analysis Center (ISAC) member organizations share the latest IOCs (Indicators of Compromise) via Structured Threat Intelligence Exchange (STIX)/Trusted Automated Exchange of Intelligence Information (TAXII) feed data by using Traffic Light Protocol (TLP). It is an industry established practice to feed Indicators of Compromise (IOCs) into Security Information and Event Management (SIEM) solutions and other protective security controls for detection of threats that are observed inside an organization.

In at least some cases, manual tools can provide some vulnerability and compromise detection and posture assessment solutions, but they are only partial in nature. However, these manual tools are prone to high rates of false positives due to log tuning and collection challenges. Many threat intelligence platforms provide extensive reporting on threat actors, campaigns, and malware families, but rely on the manual work of intel analysts for analysis and reporting. Additionally, these platforms allow organizations a way to share indicators of compromise for recently observed threats through Information Sharing Analysis and Collaboration. These indicators of compromise (IOC) are commonly integrated with Security Information and Event Management (SIEM) solutions for reactive detection when threats are observed within the enterprise.

Protective network and endpoint security controls enforce detection and blocking via vendor provided malware signatures, categorization, IP reputation, and using sandboxing techniques to assess site risk. These security vendors are reacting to the same threats, reactively providing signature updates based on telemetry and automated AI-confidence scoring. However, security vendors may not provide signatures for all active threats, especially if they are platform, application, or tool specific.

Breach and Attack Simulation (BAS) and security validation products focus on evaluating attack surfaces and performing security controls assessments focus on adversarial Tactics Techniques and Procedures (TTP) behaviors, malware/payloads, and phishing campaigns to provide instrumentation and reporting. However, BAS and attack simulation is generally not focused on assessing posture using IOCs. Security Orchestration and Automated Response (SOAR) platforms support creation of response workflow playbooks for automating the investigation and handling of security offenses/incidents, wherein SOAR is an automation platform utilized within Security Operations Centers.

Similarly, protective security controls for the proxy with site categorization and IP reputation scoring are reactive as well, with vendors providing updates that lack transparency on what is actually blocked due to being a black box in nature. Security products that are proactive in nature, like breach and attack simulation tools, do not support direction consumption of IOC data from Threat Intel platforms, and other security tools like Security Orchestration and Automated Response are focused on enabling automation for the investigation and response.

The vulnerability and compromise detection (“VCD”) systems and methods described herein describe a proactive, repeatable, and effective means of assessing a network or enterprise's security posture for the latest threats that are configured to inform and guide security operations. The VCD systems provide operational security intelligence on the effectiveness of protective security controls using Threat Intelligence data in the form of STIX/TAXII threat feeds to identify gaps. Thereby, enabling targeted threat hunts, proactive response, and providing curated Cyber Threat Intel (CTI) information.

The VCD system described herein may include, but is not limited to, the following features: providing an automated end-to-end process for assessing latest reported threats; generating empirical data based on testing about the latest Indicators of Compromise (IOCs); improving the ability to assess threats that may target protected computer networks; enabling threat hunts to verify to determine if the computer network is vulnerable to threats in known IOCs; identifying and tracking known gaps in existing protective internet security controls that may lead to security incidents; enabling proactive response for high confidence threats where threat actors could possibly obtain a foothold into the enterprise's network; and allowing for re-verification and reporting of threat posture as it changes over time.

The VCD system is configured to provide a proactive, effective, and repeatable means of testing computer networks' postures for threats. The VCD system provides intelligence about security control effectiveness using indicators of compromise (IOC), such as a malicious URL or domain, which could inform and guide security operations.

The VCD system integrates several separate security solutions together, providing the automation and logic necessary for threat intel analysts to perform the desired posture evaluation. The VCD system leverages APIs to integrate separate security solutions and handles the logic required for CTI analysts to perform the desired threat posture evaluation. The VCD system is configurable and flexible, allowing for different types of assessments to be performed: allowing selection of latest threats, individual malware families, various indicator types, country of origin, date/time ranges and more.

The consumer, such as a security team professional, supplies the IOC selection criteria to the VCD system when conducting the assessment. The consumer provides their selection criteria, which may include lower-level criteria such as particular types of domains (e.g., command and control domains). These criteria may include indicator subtypes, confidence scores, indicator status (active or inactive), metadata, and other associating the IOCs with threat actors, regions or countries, and malware families.

The VCD system retrieves the indictors from the STIX/TAXII feeds within the Threat Intelligence Platform (TIP), creates new security validation tests that safely detonates each IOC through existing internet security controls resulting in call out attempts. Each security validation test attempts to access a website, IP address, or other location outside of the computer network. The website, IP address, or other location outside of the computer network are all based on the provided IOCs. The validation test is performed in a simulated environment that simulates a workstation or computer-system on the network. During the validation test, the simulated workstation or computer-system attempts to access the website, IP address, or other location outside of the computer network through one or more internet security controls (such as a firewall). The validation test is successful if the one or more internet security controls blocks the attempted access. These attempts to access are also known as detonations, where the IOC is detonated (aka attempted to be accessed) in the simulated environment.

Once testing is complete, notifications are sent to the CTI analyst providing a report of IOCs that are not blocked. Next, the associated list of non-blocked indicators is associated with a new threat investigation for conducting hunts to verify if any computer systems in the network have clicked any phishing links or attachments that may have resulted in a successful callout and likely malicious payload being delivered. Once the IOC sweeps are returned complete, the combined results are reviewed to understand computer network's operational posture.

The VCD system provides an automated solution for assessing threats through safe detonation of indicators to proactively identify gaps in a computer network's internet security controls, then using that information to conducts hunts looking for confirmation of threats on the computer network. Thus, the VCD system provides an overall picture to CTI analysts of the computer network's posture.

By incorporating principles of threat intelligence sharing, security control testing, and empirical evidence, the VCD system enables Security Operation teams to better understand their computer network's posture, and if necessary, take proactive mitigations to reduce the likelihood of successful malware delivery and the possibility of threat actors gaining initial access to their computer network's environment.

At least one of the technical solutions to the technical problems provided by this system may include: (i) improving speed and accuracy of compromise testing; (ii) reducing the processing resources needed to scan a computer network by only scanning for those indicators of compromise that are not blocked by the network security controls; (iii) efficiently testing the security controls of a network to see if they are up to date; (iv) providing reports of potential compromises to the computer network; and (v) efficiently handling network scanning for issues of scale.

The methods and systems described herein may be implemented using computer programming or engineering techniques including computer software, firmware, hardware, or any combination or subset thereof, wherein the technical effects may be achieved by performing at least one of the following steps: a) receive a plurality of indicators of compromise associated with active threat actors, wherein the plurality of indicators of compromise are received on a periodic basis; b) generate a plurality of validation tests to test for the plurality of indicators of compromise, wherein each validation test of the plurality of validation tests is configured to test if the corresponding indicator of compromise will be blocked by one or more internet security controls; c) execute the plurality of validation tests in a simulation environment against network security controls to generate a plurality of results, wherein the simulation environment simulates a computer system on the computer network, wherein the plurality of results include message logs generated during the corresponding validation tests; d) analyze the plurality of results to detect one or more failed validation tests of the plurality of validation tests; e) scan a plurality of system and/or security logs of the computer network for indicators of compromise associated with the one or more failed validation tests, wherein the plurality of system and/or security logs include activity and message logs of a plurality of computers in the computer network; f) determine whether the computer network is compromised based on the scan of the plurality of system and/or security logs; g) instruct the one or more internet security controls to block the indicators of compromise associated with the one or more failed validation tests; h) retrieve a plurality of compromise information for each of the indicators of compromise associated with the one or more failed validation tests; i) scan the plurality of system and/or security logs of the computer network based on the plurality of compromise information; j) determine if any computer system in the computer network accessed the website based on the scan of the plurality of system and/or security logs of the computer network, wherein the indicator of compromise is a website; k) detect at least one compromised computer system based on the scan of the plurality of system and/or security logs; l) instruct the computer network to isolate the at least one compromised computer system; and m) report the plurality of results of the plurality of validation tests and results of the scan of the plurality of system and/or security logs.

### Exemplary Process for Analyzing Computer Systems and Networks for Potential Vulnerabilities

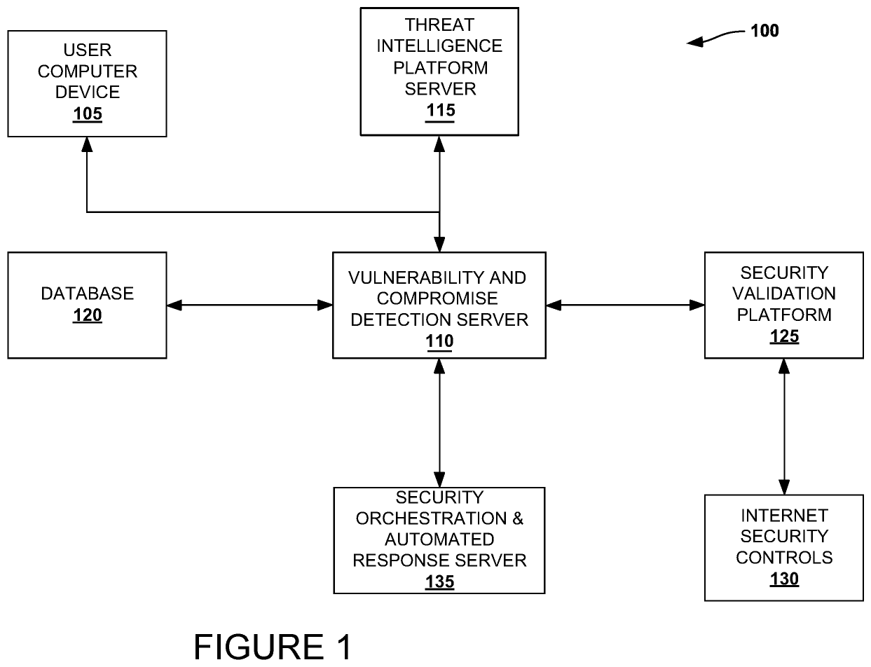

FIG. 1 illustrates a simplified block diagram of a system 100 for vulnerability and compromise detection of computer systems and networks for potential vulnerabilities to cyber-attacks, in accordance with at least one embodiment (referred to herein as the VCD system 100 or system 100). In the exemplary embodiment, the system 100 is used to monitor at least one of a computer network, a plurality of computer networks, and/or one or more computer networks associated with an enterprise or large corporation.

In the exemplary embodiment, a vulnerability and compromise detection (“VCD”) server 110 is in communication with a plurality of user computer devices 105. The user computer devices 105 may be associated with cyber threat analysts. The VCD server 110 may be in communication with the user computer devices 105 to receive selection criteria from the user of the user computer devices 105. The VCD server 110 uses the selection criteria when conducting the assessment. The user provides their selection criteria, which may include lower-level criteria such as particular types of domains (e.g., command and control domains). These criteria may also include, but is not limited to, indicator sub types, confidence scores, indicator status (active or inactive), and metadata tags associating the IOCs with threat actors and malware families. The VCD server 110 uses the selection criteria to filter received IOCs. For example, one of the selection criteria may be a confidence level associated with the IOC, and the VCD server 110 filters out any received IOCs that do not meet and/or succeed the selected confidence level. In one example, the VCD server 110 may filter out any IOC that is below 80% confidence level. In some further embodiments, the selection criteria may also filter out IOCs related to attacks outside of the industry associated with the protected computer network. For example, if a specific attack has only been seen being used in the financial sector, a video gaming company might decide to not test or prioritize the IOCs associated with that specific attack. In further embodiments, the selection criteria can include a period of time for which there are active malware domains, e.g., the past 24 hours.

The threat intelligence platform (“TIP”) 115 includes one or more servers configured to collect, aggregate, and organize threat intel data from multiple sources and formats. A TIP server 115 provides information on known malware and other threats, to allow for efficient and accurate threat identification, investigation, and response. In the exemplary embodiment, the TIP server 115 provides information in the form of an IOC (indicator of compromise) reports. The IOCs are clues and evidence of a data breach. They are forensic pieces of information that are observed and associated with an attack. For example, IOCs can include malicious URLs and IP addresses that if accessed would download compromised material onto a computer system. Examples of these can be the links found in phishing emails. IOCs may also include domain generation algorithms (DGAs) and bots used by the threat actors.

In the exemplary embodiment, threat actors compromise computer systems on a computer network when the computer system accesses a link to domains, websites, and IP addresses that lead to compromised code. These compromised sites then download malicious code onto the accessing computer system, thereby compromising the computer system. They can then use this compromise to access the computer system and potentially other computer systems on the computer network.

The TIP server 115 provides reports on found or known IOCs to the VCD server 110. The VCD server 110 filters the IOCs using the selection criteria. The remaining IOCs are then analyzed. The remaining IOCs may also be stored in one or more databases 120. The selection criteria may also be stored in the database 120. The TIP server 115 may include paid sources and open sources of IOC information. They may be selected based on attributes including, but not limited to, fidelity and/or false positives.

In some embodiments, the VCD server 110 requests the IOC report from the TIP server 115. In these embodiments, the VCD server 110 may provide the selection criteria to the TIP server 115 to retrieve those IOCS that fit within the selection criteria.

The VCD server 110 determines to complete a posture assessment for the newest reported threats in the remaining IOCs. The VCD server 110 determines to test the filtered or remaining IOCs. In some embodiments, the VCD server 110 is in communication with a security and validation platform 125. In other embodiments, the security and validation platform 125 is a part of the VCD server 110. The security and validation platform 125 and/or the VCD server 110 generates validation tests for the remaining IOCs. In at least one embodiment, the validation tests include testing to see if the proxy systems (a/k/a firewall) allow computer systems on the computer network to access the IP address/domain associated with the IOCs. These validation tests are configured to determine if the security controls are functioning as intended. In the exemplary embodiment, a validation test is performed for each IOC using Internet security controls 130. The Internet security controls 130 are proxy tools that review all communications between the computer network to the Internet, such as, but not limited to, a firewall. In some embodiments, the Internet security controls 130 are controlled and/or updated on a regular basis by a trusted third-party. In some of these embodiments, the users of the computer network are unable to directly read which domains are blocked.

Each security validation test is a block of code that attempts to access a website, IP address, or other location outside of the computer network. The website, IP address, or other location outside of the computer network are all based on the provided IOCs. The validation test is performed in a simulated environment that simulates a workstation on the network. During the validation test, the simulated workstation or computer system attempts to access the website, IP address, or other location outside of the computer network through one or more Internet security controls 130 (such as a firewall). The validation test is successful if the one or more Internet security controls 130 blocks the attempted access. These attempts to access are also known as detonations, where the IOC is detonated (aka attempted to be accessed) in the simulated environment. In some embodiments, the simulated environment accesses the live Internet security controls 130 of the computer network. In other embodiments, the security environment accesses a copy of the live internet security controls 130.

In some embodiments, the validation tests are considered IOC detonations, to see if the IOC call outs could access the threat actor, where the threat actor is being simulated by the Internet security controls 130 and/or the secure validation platform 125. The secure validation platform 125 collects the results of the IOC detonations/validation tests and reports the empirical test results to the VCD server 110.

The VCD server 110 stores the results in the database 120 and then analyzes the results. Any validation test where the simulated computer system was blocked from accessing the domain and/or IP address would be considered a success (not currently a threat to the network), because the Internet security controls 130 would prevent computer systems on the protected computer network from accessing that domain and/or IP address. Any validation test where the simulated computer system was able to reach out to a non-blocked domain, would be considered a threat. The VCD server 110 would then start a threat investigation to determine if any of these threats have been observed on the computer network.

In the exemplary embodiment, the validation tests test a virtualized standard workstation or other computer-system that is on the computer network. By using this sandbox for testing, the real network is not put at risk. Furthermore, the validation test only simulates attempting to access the domains, where the Internet security controls 130 are accessed to determine if the domain would be blocked. To determine if the test was successful or not, the VCD server 110 may search for a proxy block communication that indicates that the attempted access was successfully blocked.

In additional embodiments, the VCD server 110 analyzes the list of IOCs that were not blocked. Based on the analysis, the VCD server 110 looks for information and/or identifiers that are unique to the corresponding IOC. In the exemplary embodiment, the VCD server 110 checks for successful access to indicator location. For example, a successful callout to a malicious URL would be considered a failed validation test.

The VCD server 110 then determines whether or not that information and/or identifiers can be used to block the IOC in the future. The VCD server 110 may determine a plurality of blocking options, which may be presented to one or more users via their user computer devices 105 for confirmation and/or selection. In some embodiments, the VCD server 110 reports these blocking options to the Internet security controls 130.

In at least one embodiment, the VCD server 110 opens investigations for each non-blocked domain. The VCD server 110 requests information about hunting down the IOCs associated with the non-blocked domains, such as from a security orchestration automated response (SOAR) server 135. Using the SOAR server 135, the security validation platform 125 and/or the VCD server 110 searches for entries of accessing the non-blocked domains and other potential signs of threats to the computer network.

In at least one embodiment, the VCD server 110 searches through a plurality of log entries to determine if any computer system on the computer network has attempted to access one or more of the non-blocked domains. As the computer network gets larger, there are increased entries that the VCD server 110 has to search through/query. In some large enterprises with massive computer networks, there may be up to eight billion entries or more a day to review. Accordingly, the VCD server 110 tailors the searches to be performed as efficiently as possible. The VCD server 110 uses the search results to conduct the investigations.

The VCD server 110 analyzes the search results to see if anyone on the computer network attempted to access the non-blocked domains. If there were no attempts at access, then the corresponding investigation is closed. In some embodiments, the VCD server 110 updates the Internet security controls 130 to block the non-blocked domain. If there was one or more attempts to access the non-blocked domain, one or more user computer devices 105 are updated with reports about the access. In some further embodiments, the computer systems associated with accessing the non-blocked domains are isolated on the computer network to prevent additional compromise. In additional embodiments, the potentially compromised computer systems are blocked from accessing both inside and outside of the computer network.

In some further embodiments, the VCD server 110 may determine one or more additional actions to take to secure the potentially compromised computer systems. The VCD server 110 may also instruct the Internet security controls 130 to block the non-blocked domains.

In some embodiments, IOCs are not considered to be long lived as threat actors may change their vectors of attack and corresponding infrastructure. As many IOCs may only last 60 to 90 days before they are integrated in the security information and event management (SEIM) systems. Accordingly, the VCD system 110 may only have to search the logs for a specific number of days prior to the current one. Furthermore, the IOC reports from the TIP server 115 may indicate how long that the IOC and corresponding domain has been active. Then the VCD server 110 may search for a specific period of time prior to that active time (i.e., 7 days).

As there may be up to 500 thousand new IOCs in a week, it can be difficult for a system to parse through all of them due to the sheer numbers. Accordingly, limiting the number that need to be tested by the security validation platform 125 needs to be limited otherwise the resources needed would be astronomically. Furthermore, searching logs with millions or billions of entries would be practically impossible for most systems as well as highly inefficient. Therefore, the system 100 described herein limits the search to only those that are not currently blocked by the internet security controls 130. This limits the searching of logs to only those that may have been accessed and prevents searching on those domains that are blocked and therefore the network is already protected from.

### Exemplary Method for Analyzing Computer Networks

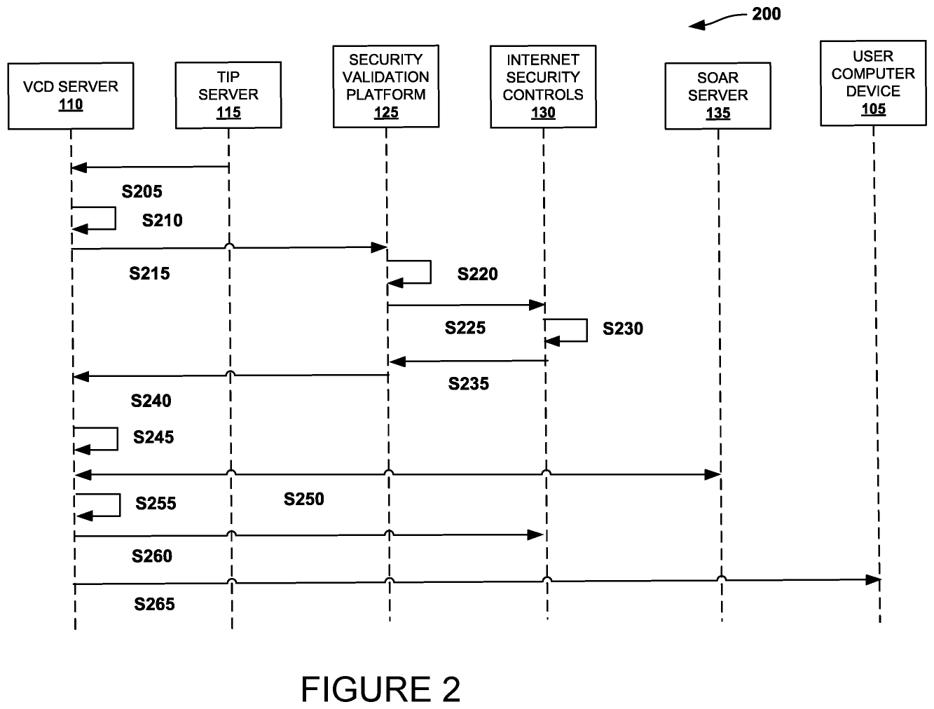

FIG. 2 illustrates a timing flow chart of an exemplary process 200 of vulnerability and compromise detection of computer systems and networks for potential vulnerabilities to cyber-attacks using the system 100 (shown in FIG. 1).

In Step S205, one or more TIP servers 115 provides a plurality of IOCs to the VCD server 110. The plurality of IOCs includes IP addresses, domain names, URLs of known malicious or threat actors. In Step S210, the VCD server 110 filters the provided plurality of IOCs based on a plurality of stored criteria. The plurality of stored criteria may be provided by one or more users of the user computer devices 105. The VCD server 110 uses the selection criteria when conducting the assessment. The users provide their selection criteria, which may include lower-level criteria such as particular types of domains (e.g., command and control domains). This criterion may also include, but is not limited to, indicator sub types, confidence score, indicator status (active or inactive), and metadata tags associating the IOCs with threat actors and malware families. The VCD server 110 uses the selection criteria to filter received IOCs. For example, one of the selection criteria may be a confidence level associated with the IOC, and the VCD server 110 filters out any received IOCs that do not meet and/or succeed the selected confidence. In one example, the VCD server 110 may filter out any IOC that is below 80% confidence level. In some further embodiments, the selection criteria may also filter out IOCs related to attacks outside of the industry associated with the protected computer network. For example, if a specific attack has only been seen being used in the financial sector, a video gaming company might decide to not test or prioritize the IOCs associated with that specific attack. In further embodiments, the selection criteria can include a period of time for which there are active malware domains, e.g., the past 24 hours.

In Step S225, the VCD server 110 provides the filtered IOCs to the security validation platform 125. In Step S220, the security validation platform 125 generates a plurality of validation tests based on the filtered IOCs. The validation tests take place in a virtual simulated environment with simulated standardized computer systems, where the environment simulates the protected computer network.

The security validation platform 125 simulates the validation test of the simulated computer system attempting to access the domain corresponding to IOC being tested. Each security validation test is a block of computer-executable code that attempts to access a website, IP address, or other location outside of the computer network. The website, IP address, or other location outside of the computer network are all based on the provided IOCs. The validation test is performed in a simulated environment that simulates a workstation on the network. During the validation test, the simulated workstation or computer system attempts to access the website, IP address, or other location outside of the computer network through one or more Internet security controls 130 (such as a firewall). The validation test is successful if the one or more Internet security controls 130 blocks the attempted access. In Step S225, the security validation platform 125 passes the access request for the domain being tested to the internet security controls 130. In Step S230, the internet security controls 130 determines whether or not to allow the access request. In Step S235, the internet security controls 130 returns the results of the access request to the security validation platform 125. In Step S240, the security validation platform 125 forwards the results of each validation test to the VCD server 110.

In Step S245, the VCD server 110 analyzes the validation tests to determine which tests where the access request was blocked versus those where the access request was allowed to pass through. For each of the results where the access request was not blocked, the VCD server 110 performs Step S250 to retrieve information about the corresponding IOCs from the SOAR server 135. In Step S255, the VCD server 110 scans the logs to determine if any computer system in the computer network has accessed any of the non-blocked domains.

In Step S260, the VCD server 110 reports the non-blocked domains to the internet security controls 130 for the internet security controls 130 to block in the future. In Step S265, the VCD server 110 reports the non-blocked domains and whether or not the non-blocked domain has been accessed by a computer system on the computer network. In some embodiments, Steps S255 and S260 occur simultaneously. In some further embodiments, Step S260 occurs before Step S255.

### Exemplary Computer-Implemented Method for Analyzing Computer Networks

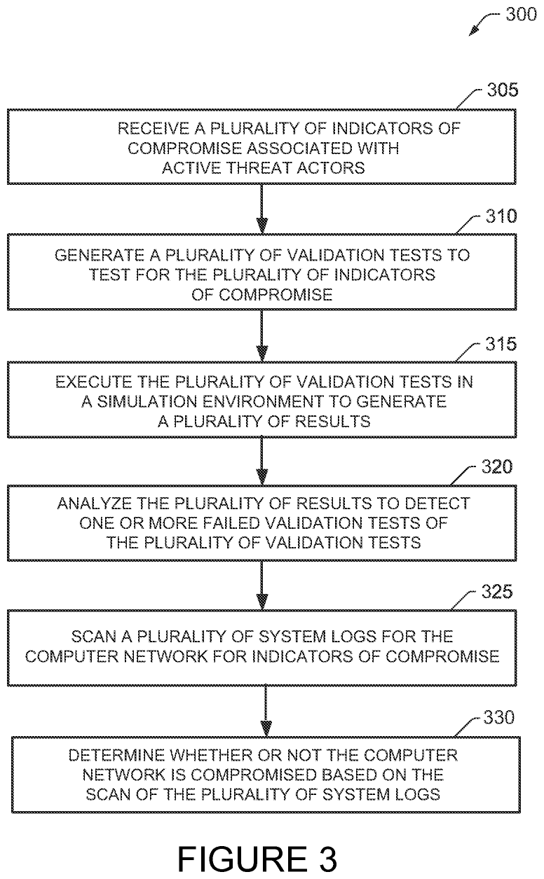

FIG. 3 illustrates a flow chart of an exemplary computer-implemented process 300 for vulnerability and compromise detection of computer systems and networks for potential vulnerabilities to cyber-attacks as shown in FIG. 2 using the system shown in FIG. 1. Process 300 may be implemented by a computing device, for example VCD server 110 (shown in FIG. 1) and/or security validation platform 125 (shown in FIG. 1). In the exemplary embodiment, VCD server 110 may be able to communicate with at least one user computer device 105, TIP server 115, and/or SOAR server 135 (all shown in FIG. 1).

In the exemplary embodiment, the VCD server 110 may receive 305 a plurality of indicators of compromise (IOCs) associated with active threat actors. The active threat actors may be chosen by security analysts. In some embodiments, the VCD server 110 receives 305 the from one or more TIP servers 115. In some of these embodiments, the TIP server 115 transmits the IOCs on a periodic basis. In other embodiments, the VCD server 110 requests the IOCs.

In the exemplary embodiment, the VCD server 110 may generate 310 a plurality of validation tests to test for the plurality of indicators of compromise. In some embodiments, the plurality of validation tests is generated by the security validation platform 125. In some embodiments, each validation test of the plurality of validation tests is configured to test if the corresponding indicator of compromise will be blocked by one or more internet security controls 130.

Each security validation test is a block of code that attempts to access a website, IP address, or other location outside of the computer network. The website, IP address, or other location outside of the computer network are all based on the provided IOCs. The validation test is performed in a simulated environment that simulates a workstation on the network. During the validation test, the simulated workstation attempts to access the website, IP address, or other location outside of the computer network through one or more Internet security controls 130 (such as a firewall). The validation test is successful if the one or more Internet security controls 130 blocks the attempted access.

In the exemplary embodiment, the VCD server 110 may execute 315 the plurality of validation tests in a simulation environment to generate a plurality of results. The simulation environment simulates a computer system on the computer network. In some embodiments, the simulation environment is based on network security controls.

In the exemplary embodiment, the VCD server 110 may analyze 320 the plurality of results to detect one or more failed validation tests of security controls of the plurality of validation tests. The plurality of results may include message logs during the corresponding validation test.

In the exemplary embodiment, the VCD server 110 may scan 325 a plurality of system and/or security logs of the computer network for indicators of compromise associated with the one or more failed validation tests. The plurality of system and/or security logs may include activity and message logs of a plurality of computers in the computer network.

In the exemplary embodiment, the VCD server 110 may determine 330 whether or not the computer network is compromised based on the scan of the plurality of system and/or security logs.

In some further embodiments, the VCD server 110 retrieves a plurality of compromise information for each of the indicators of compromise associated with the one or more failed validation tests. The VCD server 110 scans the plurality of system and/or security logs of the computer network based on the plurality of compromise information.

In some embodiments, the indicator of compromise is a website. The VCD server 110 determines if any computer system in the computer network accessed the website based on the scan of the plurality of system and/or security logs of the computer network

In some further embodiments, the VCD server 110 may instruct the one or more internet security controls 130 to block the indicators of compromise associated with the one or more failed validation tests.

In still further embodiments, the VCD server 110 may detect at least one compromised computer system based on the scan of the plurality of system log. The VCD server 110 may instruct the computer network to isolate the at least one compromised computer system.

In at least one embodiment, the VCD server 110 reports the plurality of results of the plurality of validation tests and results of the scan of the plurality of system and/or security logs.

### Exemplary Computer Network

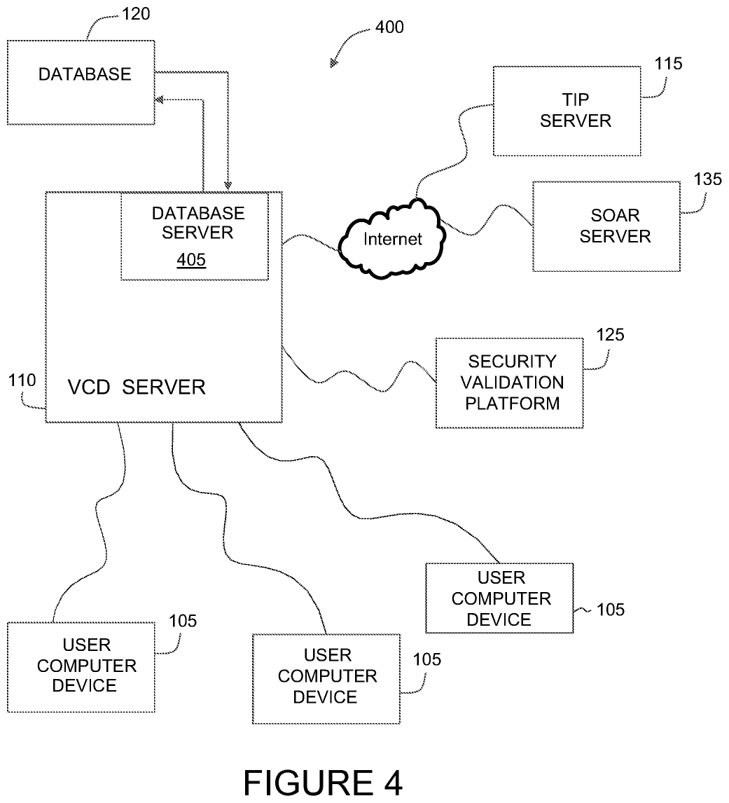

FIG. 4 illustrates a simplified block diagram of an exemplary system 400 for implementing the process 200 (shown in FIG. 2) and the process 300 (shown in FIG. 3). In the exemplary embodiment, system 400 may be used for vulnerability and compromise detection of computer systems and networks for potential vulnerabilities to cyber-attacks. As described below in more detail, a vulnerability and compromise detection (“VCD”) computer system, also known as vulnerability and compromise detection (“VCD”) server 110, may be configured to (i) receive a plurality of indicators of compromise associated with active threat actors; (ii) generate a plurality of validation tests to test for the plurality of indicators of compromise; (iii) execute the plurality of validation tests in a simulation environment to generate a plurality of results; (iv) analyze the plurality of results to detect one or more failed validation tests of the plurality of validation tests; (v) scan a plurality of system and/or security logs of the computer network for indicators of compromise associated with the one or more failed validation tests; and (vi) determine whether the computer network is compromised based on the scan of the plurality of system and/or security logs.

In the exemplary embodiment, user computer devices 105 may be computers that include a web browser or a software application, which enables user computer devices 105 to access remote computer devices, such as the VCD server 110, using the Internet or other network. More specifically, user computer devices 105 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 105 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 405 may be communicatively coupled to a database 120 that stores data. In one embodiment, database 120 may include scan data, vulnerabilities, IOCs, and domains. In the exemplary embodiment, database 120 may be stored remotely from VCD server 110. In some embodiments, database 120 may be decentralized. In the exemplary embodiment, a user may access database 120 via user computer device 105 by logging onto the VCD server 110, as described herein.

The VCD server 110 may be in communication with a plurality of user computer devices 105 to receive selection criteria and to transmit reports to at least one of the plurality of user computer devices 105. In some embodiments, the VCD server 110 may host or include artificial intelligence functionality, such as security validation platform 125, where the security validation platform 125 performs the steps of either process 200 and/or process 300. In some embodiments, VCD server 110 may be a plurality of computer devices working in concert to perform the steps outlined herein.

In the exemplary embodiment, TIP servers 115 are websites, servers, systems, and services that describe potential vulnerabilities in computer systems and computer software. The TIP server 115 may include, but is not limited to, databases, bulletin boards, forums, marketplaces, or other types of websites that may explain discovered threat actors, IOCs, and vulnerabilities. The TIP servers 115 may include, but are not limited to, Common Vulnerabilities and Exposures (CVE) databases, exploit databases, threat intel databases, data markets, and/or Dark Wikis.

### Exemplary Client Device

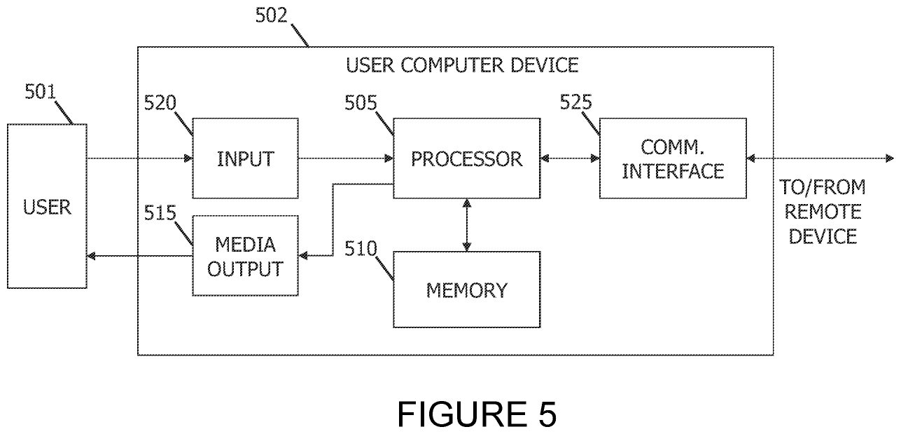

FIG. 5 depicts an exemplary configuration of a client computer device, in accordance with one embodiment of the present disclosure. User computer device 502 may be operated by a user 501. User computer device 502 may include, but is not limited to, user computer device 105 (shown in FIG. 1). User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing reports on the results of executed exploits. In some embodiments, user computer device 502 may include an input device 520 for receiving input from user 501. User 501 may use input device 520 to, without limitation, provide a computer network to analyze.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as VCD server 110 (shown in FIG. 1). Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from VCD server 110. A client application may allow user 501 to interact with, for example, VCD server 110. For example, instructions may be stored by a cloud service, and the output of the execution of the instructions sent to the media output component 515.

### Exemplary Server Device

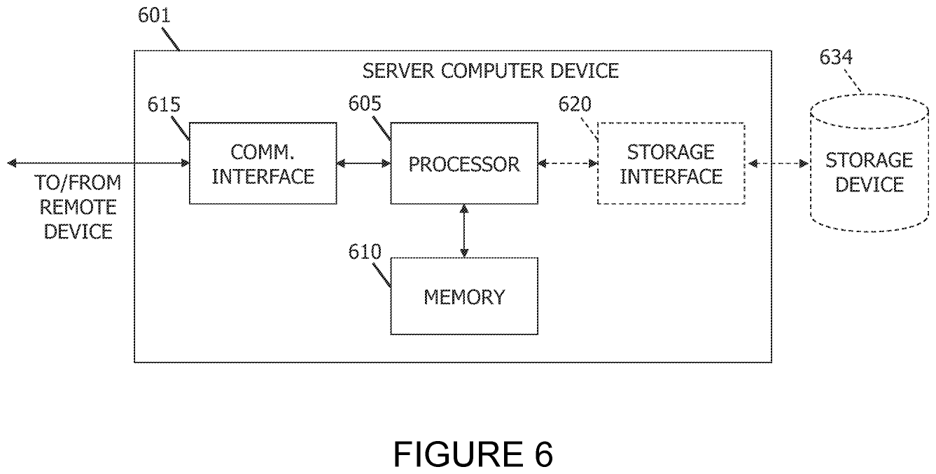

FIG. 6 depicts an exemplary configuration of a server system, in accordance with one embodiment of the present disclosure. Server computer device 601 may include, but is not limited to, VCD server 110, TIP server 115, security validation platform 125, internet security controls 130, SOAR server 135 (all shown in FIG. 1), PT server 410, and database server 405 (shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, VCD server 110, TIPS server 115, SOAR server 135, and user computer devices 105 (shown in FIG. 1) (e.g. using wireless communication or data transmission over one or more radio links or digital communication channels). For example, communication interface 615 may receive requests from user computer devices 105 via the Internet, as illustrated in FIG. 1.

Processor 605 may also be operatively coupled to a storage device 634. Storage device 634 may be any computer-operated hardware suitable for storing and/or retrieving data, such as, but not limited to, data associated with database 120 (shown in FIG. 1). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 2 and 3.

### Exemplary Embodiments & Functionality

In one aspect, a vulnerability and compromise detection (“VCD”) system for testing and analyzing computer networks for potential vulnerabilities to cyber-attacks is provided. The VCD system includes at least one computer device including at least one processor in communication with at least one memory device. The at least one processor is programmed to receive a plurality of indicators of compromise associated with active threat actors. The at least one processor is also programmed to generate a plurality of validation tests to test for the plurality of indicators of compromise. The at least one processor is further programmed to execute the plurality of validation tests in a simulation environment to generate a plurality of results. In addition, the at least one processor is programmed to analyze the plurality of results to detect one or more failed validation tests of the plurality of validation tests. Moreover, the at least one processor is programmed to scan a plurality of system and/or security logs of the computer network for indicators of compromise associated with the one or more failed validation tests. Furthermore, the at least one processor is programmed to determine whether the computer network is compromised based on the scan of the plurality of system and/or security logs. Additionally, the at least one processor is programmed to report threat posture information about computer network and systems as a form of threat intelligence. Lastly, the at least one processor is programmed to generate a computer and network systems IOC threat posture report for the active threats. The system may have additional, less, or alternate functionalities, including those discussed elsewhere herein.

In another aspect, a computer-based method for testing and analyzing computer networks for potential vulnerabilities to cyber-attacks is provided. The method is implemented on a vulnerability and compromise detection (“VCD”) computer device including at least one processor in communication with at least one memory device. The method includes receiving a plurality of indicators of compromise associated with active threat actors. The method also includes generating a plurality of validation tests to test for the plurality of indicators of compromise. The method further includes executing the plurality of validation tests in a simulation environment to generate a plurality of results. In addition, the method includes analyzing the plurality of results to detect one or more failed validation tests of the plurality of validation tests. Moreover, the method includes scanning a plurality of system and/or security logs of the computer network for indicators of compromise associated with the one or more failed validation tests. Furthermore, the method includes determining whether or not the computer network is compromised based on the scan of the plurality of system and/or security logs. Additionally, the method includes reporting threat posture information about computer network and systems as a form of threat intelligence. Lastly, the method includes creating a computer and systems IOC threat posture report for the active threats. The method may have additional, less, or alternate functionalities, including those discussed elsewhere herein.

In yet another aspect, at least one non-transitory computer-readable storage media having computer-executable instructions embodied thereon may be provided. When executed by at least one processor, the computer-executable instructions may cause the processor to receive a plurality of indicators of compromise associated with active threat actors. The computer-executable instructions may also cause the processor to generate a plurality of validation tests to test for the plurality of indicators of compromise. The computer-executable instructions may further cause the processor to execute the plurality of validation tests in a simulation environment to generate a plurality of results. In addition, the computer-executable instructions may cause the processor to analyze the plurality of results to detect one or more failed validation tests of the plurality of validation tests. Moreover, the computer-executable instructions may cause the processor to scan a plurality of system and/or security logs of a computer network for indicators of compromise associated with the one or more failed validation tests. Furthermore, the computer-executable instructions may cause the processor to determine whether the computer network is compromised based on the scan of the plurality of system and/or security logs. Additionally, the computer executable instructions may cause the processor to report threat posture information about computer network and systems as a form of threat intelligence. Lastly, the computer executable instructions may cause the processor to generate a computer and systems IOC threat posture report for the active threats. The computer-readable storage media may have additional, less, or alternate functionalities, including those discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing sensor data, generating exploits, and/or identifying vulnerabilities, authentication data, image data, mobile device data, and/or other data.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

As used herein, the term “cybersecurity threat” includes an unauthorized attempt to gain access to a subject system. Cybersecurity threats, also known as cyber-attacks or cyber-threats, attempt to breach computer systems by taking advantage of vulnerabilities in the computer systems. Some cybersecurity threats include attempts to damage or disrupt a subject system. These cybersecurity threats can include, but are not limited to, active intrusions, spyware, malware, viruses, and worms. Cybersecurity threats may take many paths (also known as attack paths) to breach a system. These paths may include operating system attacks, misconfiguration attacks, application-level attacks, and shrink wrap code attacks. Cybersecurity threats may be introduced by individuals or systems directly accessing a computing device, remotely via a communications network or connected system, or through an associated supply chain.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A vulnerability and compromise detection (“VCD”) system for testing and analyzing computer networks for potential vulnerabilities to cyber-attacks, the VCD system comprising at least one computer device comprising at least one processor, and at lease one memory device in communication therewith, the at least one processor programmed to:
receive a plurality of indicators of compromise associated with active threat actors;
generate a plurality of validation tests to test for the plurality of indicators of compromise;
execute the plurality of validation tests in a simulation environment to generate a plurality of results;
analyze the plurality of results to detect one or more failed validation tests of the plurality of validation tests;
scan a plurality of system logs of a computer network for indicators of compromise associated with the one or more failed validation tests; and
determine whether the computer network is compromised based on the scan of the plurality of system logs.

2. The VCD system in accordance with claim 1, wherein the at least one processor is further programmed to report threat posture information about the computer network and related systems as a form of threat intelligence.

3. The VCD system in accordance with claim 1, wherein the plurality of indicators of compromise are received on a periodic basis.

4. The VCD system in accordance with claim 1, wherein each validation test of the plurality of validation tests is configured to test if the corresponding indicator of compromise will be blocked by one or more Internet security controls, wherein each validation test of the plurality of validation tests is performed in a simulated environment in communication with the one or more internet security controls.

5. The VCD system in accordance with claim 4, wherein the at least one processor is further programmed to instruct the one or more Internet security controls to block the indicators of compromise associated with the one or more failed validation tests.

6. The VCD system in accordance with claim 1, wherein the simulation environment simulates a computer system on the computer network.

7. The VCD system in accordance with claim 1, wherein the plurality of results includes message logs generated during the corresponding validation tests.

8. The VCD system in accordance with claim 1, wherein a validation test succeeds if one or more Internet security controls blocks access during the validation test.

9. The VCD system in accordance with claim 1, wherein the plurality of system logs includes activity and message logs of a plurality of computers in the computer network.

10. The VCD system in accordance with claim 1, wherein the at least one processor is further programmed to:
retrieve a plurality of compromise information for each of the indicators of compromise associated with the one or more failed validation tests; and
scan the plurality of system logs of the computer network based on the plurality of compromise information.

11. The VCD system in accordance with claim 1, wherein the indicator of compromise is a website, and wherein the at least one processor is further programmed to determine if any computer system in the computer network accessed the website based on the scan of the plurality of system logs of the computer network.

12. The VCD system in accordance with claim 1, wherein the at least one processor is further programmed to:
detect at least one compromised computer system based on the scan of the plurality of system logs; and
instruct the computer network to isolate the at least one compromised computer system.

13. The VCD system in accordance with claim 1, wherein the at least one processor is further programmed to report the plurality of results of the plurality of validation tests and results of the scan of the plurality of system logs.

14. A computer-based method for testing and analyzing computer networks for potential vulnerabilities to cyber-attacks, the method implemented on a vulnerability and compromise detection (“VCD”) computer device including at least one processor in communication with at least one memory device, the method comprising:
receiving a plurality of indicators of compromise associated with active threat actors;
generating a plurality of validation tests to test for the plurality of indicators of compromise;
executing the plurality of validation tests in a simulation environment to generate a plurality of results;
analyzing the plurality of results to detect one or more failed validation tests of the plurality of validation tests;
scanning a plurality of system logs of a computer network for indicators of compromise associated with the one or more failed validation tests; and
determining whether the computer network is compromised based on the scan of the plurality of system logs.

15. The method in accordance with claim 14 further comprising reporting threat posture information about the computer network and related systems as a form of threat intelligence.

16. The method in accordance with claim 14, wherein the plurality of indicators of compromise are received on a periodic basis.

17. The method in accordance with claim 14, wherein each validation test of the plurality of validation tests is configured to test if the corresponding indicator of compromise will be blocked by one or more Internet security controls.

18. The method in accordance with claim 17 further comprising instructing the one or more Internet security controls to block the indicators of compromise associated with the one or more failed validation tests.

19. The method in accordance with claim 14, wherein the simulation environment simulates a computer system on the computer network.

20. The method in accordance with claim 14, wherein a validation test succeeds if the one or more Internet security controls blocks access during the validation test.

21. The method in accordance with claim 14, wherein the plurality of results includes message logs generated during the corresponding validation tests.

22. The method in accordance with claim 14, wherein the plurality of system logs includes activity and message logs of a plurality of computers in the computer network.

23. The method in accordance with claim 14 further comprising:
retrieving a plurality of compromise information for each of the indicators of compromise associated with the one or more failed validation tests; and
scanning the plurality of system logs of the computer network based on the plurality of compromise information.

24. The method in accordance with claim 14, wherein the indicator of compromise is a website, and wherein the method further comprises determining if any computer system in the computer network accessed the website based on the scan of the plurality of system logs of the computer network.

25. The method in accordance with claim 14 further comprising:
detecting at least one compromised computer system based on the scan of the plurality of system logs; and
instructing the computer network to isolate the at least one compromised computer system.

26. The method in accordance with claim 14 further comprising reporting the plurality of results of the plurality of validation tests and results of the scan of the plurality of system logs.

27. At least one non-transitory computer-readable storage media having computer-executable instructions embodied thereon, wherein when executed by at least one processor, the computer-executable instructions cause the processor to:
receive a plurality of indicators of compromise associated with active threat actors;
generate a plurality of validation tests to test for the plurality of indicators of compromise;
execute the plurality of validation tests in a simulation environment to generate a plurality of results;
analyze the plurality of results to detect one or more failed validation tests of the plurality of validation tests;
scan a plurality of system logs of a computer network for indicators of compromise associated with the one or more failed validation tests; and
determine whether the computer network is compromised based on the scan of the plurality of system logs.
